(19) United States
(12) Patent Application Publication
(10) Pub. No.: US 2012/0121226 A1
(43) Pub. Date: May 17, 2012

(54) INTERLOCKING OPTICAL FIBER

(75) Inventors: Scott G. Fleischman, Palmetto, FL (US); Richard Kallay, Largo, FL (US)

(73) Assignee: HONEYWELL INTERNATIONAL INC., Morristown, NJ (US)

(21) Appl. No.: 12/948,172

(22) Filed: Nov. 17, 2010

(51) Int. Cl. G02B 6/02; C03C 25/10; G02B 6/38; C03B 37/02

(52) U.S. Cl. 385/123; 65/435; 65/411; 65/403; 65/430; 65/537

(57) ABSTRACT

An optical fiber includes an outer periphery formed into a shape that configures the fiber to interlock with the other fibers with complementary shapes. Methods and systems for fabricating such interlocking fibers are also disclosed. In one example, a method includes drawing a first optical fiber from a preform and forming an outer periphery of the first optical fiber into a shape that configures the first optical fiber to be interlocked with a second optical fiber comprising an outer periphery formed into a shape that is complementary to the shape of the first optical fiber.

### TECHNICAL FIELD

The disclosure relates to optical fibers.

### BACKGROUND

Communications, data transmission, and various other systems that transmit information can employ a plurality of optical fibers, due to, at least in part, their signal transmission capabilities, which greatly exceed those of some electrical conductors. For example, signals may travel along optical fibers with less loss compared to electrical conductors, and optical fibers can also be immune to electromagnetic interference.

### SUMMARY

In general, this disclosure is directed to techniques for increasing the mechanical stability of and reducing the complexity of fabricating optical fiber assemblies. Examples according to this disclosure include optical fibers, as well as systems and methods for fabricating such fibers that include an outer periphery formed into a shape that configures each of the fibers to interlock with the other fibers.

In one example, a method includes drawing a first optical fiber from a preform and forming an outer periphery of the first optical fiber into a shape that configures the first optical fiber to be interlocked with a second optical fiber comprising a complementary outer periphery shape.

In another example, an optical fiber includes a core, a cladding surrounding the core, and a coating surrounding the cladding. At least one of the core, the cladding, or the coating includes an outer periphery formed in a shape that configures the optical fiber to be interlocked with another optical fiber comprising a complementary outer periphery shape.

In another example, a system for manufacturing optical fibers includes a preform from which an optical fiber is drawn and a die. The die includes an orifice through which the optical fiber is drawn and by which an outer periphery of the optical fiber is formed into a shape that configures the optical fiber to be interlocked with another optical fiber comprising a complementary outer periphery shape.

In another example, a method includes providing a first optical fiber comprising an outer periphery defining an interlocking shape, providing a second optical fiber comprising an outer periphery defining an interlocking shape that is complementary to the interlocking shape of the first optical fiber, and interlocking the first optical fiber with the second optical fiber.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic diagram of an example optical fiber drawing tower configured to fabricate optical fibers including an interlocking shape.

FIG. 2 is a plan view of an example coating die from the drawing tower of FIG. 1.

FIG. 3 is a schematic cross-sectional view of an optical fiber assembly including a number of optical fibers interlocked with one another.

FIGS. 4A-4B are schematic cross-sectional views of three example coated optical fibers according to this disclosure.

FIGS. 5A-5C are schematic cross-sectional views of a number of optical fiber assemblies corresponding to the example optical fibers of FIGS. 4A-4C.

FIG. 6 illustrates an example optical fiber including a number of twisting grooves formed in the outer periphery of the fiber.

FIG. 7 is a flowchart illustrating an example method of fabricating an optical fiber.

FIG. 8 is a schematic diagram of another example optical fiber drawing tower configured to fabricate optical fibers including an interlocking shape.

### DETAILED DESCRIPTION

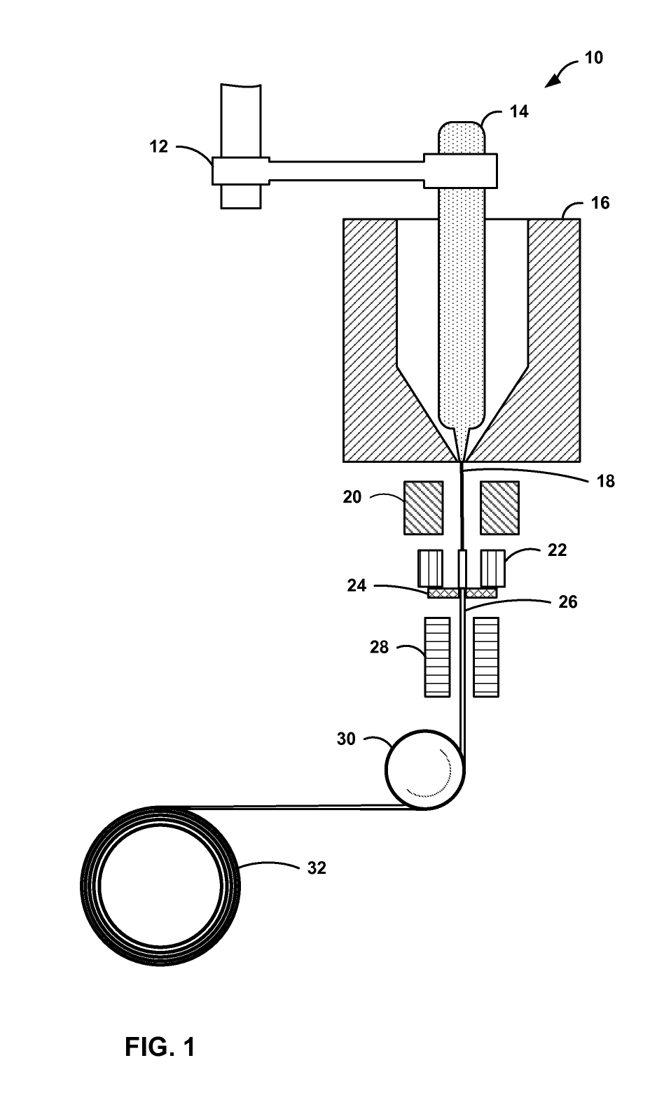

FIG. 1 is a schematic diagram of example optical fiber drawing tower 10 including feed arm 12, preform 14, draw furnace 16, optical fiber 18, core monitor 20, coating applicator 22, die 24, coated fiber 26, curing equipment 28, tractor belt 30, and take-up drum 32. Drawing tower 10 is configured to produce optical fiber 26. In the example shown in FIG. 1, tractor belt 30 draws optical fiber 18, which may include a fiber core and cladding, from preform 14 and winds up the fiber on take-up drum 32. Between draw furnace 16 and tractor belt 30, fiber 18 is coated by coating applicator 22 to form coated fiber 26, which includes a fiber core, cladding, and coating. Coated fiber 26 is configured to interlock with other fibers.

In some optical fiber applications, a number of optical fibers are coupled to one another to form an array of side-by-side fibers. The manner in which the fibers have been mechanically coupled to form such arrays in the past has included adhering adjacent fibers to one another and adhering a number of fibers to some kind of substrate or backing sheet. Although optical fibers offer a number of significant advantages in various information transmission applications, their manufacture and assembly still present difficulties that increase the cost and complexity of realizing such gains in practice. As such, examples according to this disclosure are directed to techniques for forming the outer periphery of an optical fiber in a shape that configures the fiber to interlock with other fibers with a complementary shape. Such optical fibers may then be interlocked with one another to form optical fiber assemblies, which can include one-dimensional and multi-dimensional arrays of optical fibers. In some examples, such interlocking fibers according to this disclosure may be assembled with satisfactory mechanical stability such that additional materials and processing steps, such as applying an adhesive may not be necessary.

As illustrated in the example of FIG. 1, optical fiber 18 is fabricated from preform 14. A preform can be a cylinder of silica composition that may consist of a core surrounded by a cladding with a particular refractive-index profile, attenuation, and other target characteristics for the optical fiber produced from the preform. In other words, the preform may emulate the optical fiber that is produced from the preform, but on a larger scale. For example, preform 14 may have a diameter in a range from approximately 10 to approximately 25 millimeters and a length in a range from approximately 60 to approximately 120 centimeters. Optical fiber 18 drawn from preform 14, however, may have a diameter on the order of approximately 125 microns (μm). Other preform and optical fiber dimensions are contemplated.

There are a number of different methods that may be employed to produce preform 14, including, but not limited to: Internal Deposition, where material is grown inside a tube; Outside Deposition, where material is deposited on a mandrel, which can be removed in a later stage; and Axial Deposition, where material is deposited axially, directly on a glass preform. In some examples, preform 14 is fabricated by vapor-phase oxidation, in which a number of gases, e.g., silicon tetrachloride (SiCl₄) and oxygen (O₂), are mixed at a relatively high temperature to produce a material, e.g., silicon dioxide (SiO₂), that is deposited layer-upon-layer to build up the preform core.

Silicon dioxide, pure silica, or other materials forming the core of preform 14 may be in the form of small particles (e.g., on the order of about 0.1 μm), which can be referred to as “soot.” This soot may be deposited on a starting rod or tube in a deposition process. In some examples, the soot for the core material of preform 14 is made by mixing three gases: SiCl₄, germanium tetrachloride (GeCl₄), and O₂, which results in a mixture of SiO₂ and germanium dioxide (GeO₂). The degree of doping of the core may be controlled by changing the amount of GeCl₄ gas added to the mixture. The deposition of silica soot, layer upon layer, may also act to form a homogeneous transparent cladding material. In some examples, various dopants may be employed to change the value of a cladding's refractive index. For example, fluorine (F) may be used to decrease the cladding's refractive index in a depressed-cladding configuration. Thus, in some examples, preform 14 may be comprised of two generally concentric glass structures: the core, which is configured to carry light signals, and the cladding, which is configured to trap the light in the core.

In one example, preform 14 is produced by Modified Chemical Vapor Deposition (MCVD), which is a type of Internal Deposition. MCVD is a process for fabricating preforms in which the preform core material is deposited on the inside surface of a starting tube. For example, individual layers of deposited material may be vitrified, i.e., turned into glass by a torch that moves back and forth along the length of the starting tube. Material deposition may occur as the torch assembly slowly traverses the length of the starting tube, while reactant gasses are pumped into and exhausted from the tube. Following the deposition of core material and some cladding material, the starting tube may be collapsed to form a solid rod by heating the tube to a higher temperature than during deposition. The silica glass starting tube may thus become part of the cladding of preform 14. In one example, the cladding of preform 14 may be further increased by an overcladding (also referred to as sleeving or overcollapse) process, during which another silica tube is collapsed on the outside of the original preform, thereby increasing the geometrical dimensions of preform 14.

Regardless of the particular configuration or method of manufacturing preform 14, in drawing tower 10 of FIG. 1, feed arm 12 positions preform within draw furnace 16, which may heat the tip of the preform in preparation for drawing optical fiber 18. Feed arm 12 may be part of a number of different types of partially or completely automated material positioning machines, including, e.g., robotics equipment or other computer controlled machinery including, e.g., machines operated using a programmable logic controller (PLC).

To begin drawing optical fiber 18, preform 14 is lowered into and heated within draw furnace 16. In one example, draw furnace 16 may include a high-purity graphite furnace. After preform 14 is positioned within draw furnace 16 by feed arm 12, in one example, gasses may be injected into the furnace to provide a relatively clean and conductive atmosphere. In furnace 16, preform 14 is heated to a temperature that produces a desired drawing tension in optical fiber 18. In one example, preform 14 is heated to temperatures approaching approximately 1600° C. (3000° F.) to soften the tip of the preform. In any event, the tip of preform 14 may be heated until a piece of molten glass, referred to as a gob, begins to fall from the preform, much like hot taffy. As gravity causes the gob to fall from preform 14, it pulls behind it a thin strand of glass, which forms the beginning of optical fiber 18.

In one example, the gob from preform 14 may be cut off, and the beginning of optical fiber 18 may be threaded through core monitor 20, coating applicator 22, die 24, and curing equipment 28 to tractor belt 30. As the tip of preform 14 continues to be heated within draw furnace 16, tractor 30 draws optical fiber 18 from the preform through the equipment of drawing tower 10 and winds the fiber around take-up drum 32. Drawing tower 10 may, in one example, draw optical fiber 18 at speeds in a range from approximately 10 to approximately 20 meters per second, although other speeds can be used in other examples.

During the draw process the dimensions of optical fiber 18 may be monitored and controlled using core monitor 20. In one example, core monitor includes a laser-based diameter gauge configured to monitor the diameter of optical fiber 18. Employing core monitor 20, the diameter of optical fiber 18 may, in some examples, be controlled to, e.g., 125 microns within a tolerance of 1 micron, although optical fiber 18 can have other dimensions in other examples. In operation, core monitor 20 may sample the diameter of optical fiber 18 at relatively high frequencies, e.g., in excess of 750 Hz. The value of the diameter of optical fiber 18 measured by core monitor 20 may be compared to a target diameter, e.g., 125 microns. A processor controlling all or part of the operation of drawing tower 10 can convert deviations from the target diameter into changes in draw speeds, and may control tractor belt 30 to adjust the draw speed for optical fiber 18 through draw tower 10. Processors in examples according to this disclosure may include any one or more of a microprocessor, a controller, a digital signal processor (DSP), an application specific integrated circuit (ASIC), a field-programmable gate array (FPGA), or equivalent discrete or integrated logic circuitry. The functions attributed to such processors in this disclosure may be embodied as software, firmware, hardware and combinations thereof. Additionally, in some examples one processor may be employed, while in other examples multiple processors that are configured to execute one or more functions individually or in different cooperative combinations may be employed. For example, if core monitor 20 determines that the diameter of optical fiber 18 has increased above its target, tractor belt 30 may increase the drawing speed. If, on the other hand, core monitor 20 determines that the diameter of optical fiber 18 has fallen below the target, tractor belt 30 may decrease the drawing speed.

After exiting core monitor 20, optical fiber 18 enters coating applicator 22, in which a protective coating may be applied to the fiber to form coated fiber 26. In some examples, coating applicator 22 may apply multiple coatings to optical fiber 18. For example, coating applicator 22 may apply a two layer protective coating including a soft inner coating and a hard outer coating. The protective coating, however many layers, may act to provide mechanical protection for handling optical fiber 18 and also protecting the highly finished surface of the fiber from harsh environments. Coating applicator 22 may apply various types of coatings to optical fiber 18 to form coated fiber 26, such as various ultra-violate curable urethane acrylate coatings. Coatings applied to optical fiber 18 by applicator 22 may be cured by curing equipment 28, which may include, e.g., a furnace or UV lamps.

Optical fiber 18 drawn from preform 14 may have a generally round cross-sectional shape and, thus, may define an elongated cylinder after being drawn from drawing tower 10. For example, optical fiber 18 may have a generally circular cross-sectional shape such that the drawn fiber forms a generally circular elongated cylinder. In another example, optical fiber 18 may have a generally oval cross-sectional shape such that the drawn fiber forms a generally oval elongated cylinder. The shape of optical fiber 18 may be configured to enhance the optical and environmental performance of the fiber, while having little to no impact on other factors such as the manufacturing processes or mechanical stability of optical fiber assemblies.

The coating applied to optical fiber 18 by coating applicator 22 may generally assume the shape of the optical fiber such that, without further processing, an outer periphery of coated fiber 26 would be formed in generally the same shape as the outer periphery of optical fiber 18. The shape of the coating applied to optical fiber 18, unlike the fiber itself, may have little to no impact on the optical and environmental performance of the fiber. Examples coated fibers 26 and methods according to this disclosure may improve the manufacturing process and mechanical stability of optical fiber assemblies by modifying the shape of the protective coatings applied to such fibers. In the example of FIG. 1, the shape of coated fiber 26 is defined by coating die 24, which is interposed between coating applicator 22 and curing equipment 28. Thus, in the example of FIG. 1, the shape of coated fiber 26, and, in particular, the shape of the outer periphery of the coated fiber is defined as coating applicator applies the coating to optical fiber 18, but before the coating is hardened by curing equipment 28.

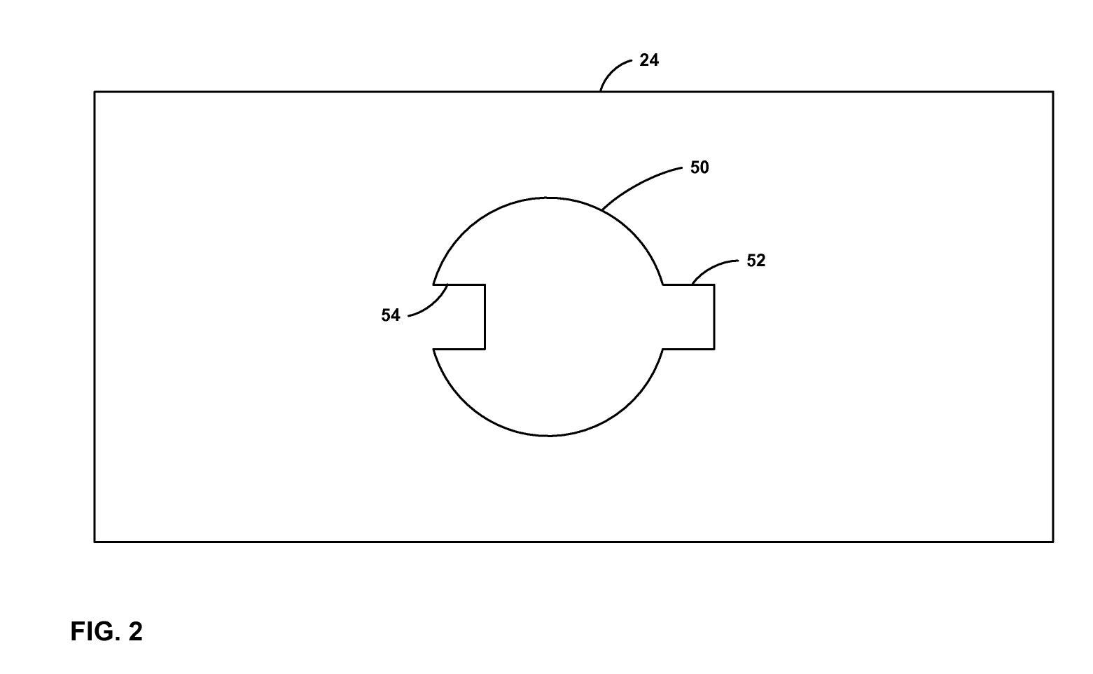

FIG. 2 is a plan view of an example of coating die 24 of drawing tower 10 of FIG. 1. As illustrated in the examples of FIGS. 1 and 2, coating die 24 may be a plate that defines orifice 50, which is configured to impart a shape to the outer periphery of coated fiber 26 as it exits coating applicator 22. In the example of FIG. 2, orifice 50 includes tongue 52 and groove 54. Coating die 24 may be fabricated from any suitable material, including, e.g., metals, metal alloys, ceramics, or plastics. In some examples, die 24 is manufactured by a solid material manufacturing methods, such as, but not limited to, any one or more of various material removal process, including, e.g., milling, electrical discharge machining (EDM), or laser or torch cutting. Coating die 24 may also be manufactured, in some examples, by stamping, injection molding, or casting.

Coating die 24 and, in particular, orifice 50 is configured to form coated fiber 26 in drawing tower 10 of FIG. 1 into a shape that configures the fiber to interlock with other fibers with a complementary shape. In the example of FIG. 2, orifice 50 includes tongue 52 and groove 54 and is configured to impart the tongue 52 and groove 54 shape to the outer periphery of coated fiber 26. In the example of FIG. 2, tongue 52 is generally on an opposite side of groove 54 on the periphery of orifice 50. However, in other examples, tongue 52 and groove 54 may be arranged at any number of different positions around the periphery of orifice 50, as well as with respect to one another. In the example of FIG. 2, coated fiber 26 that is formed as it is passed through orifice 50 of coating die 24 from coating applicator 22 includes an outer periphery with a tongue and groove shape that corresponds to tongue 52 and groove 54 of orifice 50. The tongue and groove defined by the outer periphery of coated fiber 26 configures the fiber to interlock with other fibers with complementary shapes, e.g. other fibers with the same or similar tongue and groove shape or including one of a tongue or a groove configured to be received by or receive the groove and tongue of fiber 26.

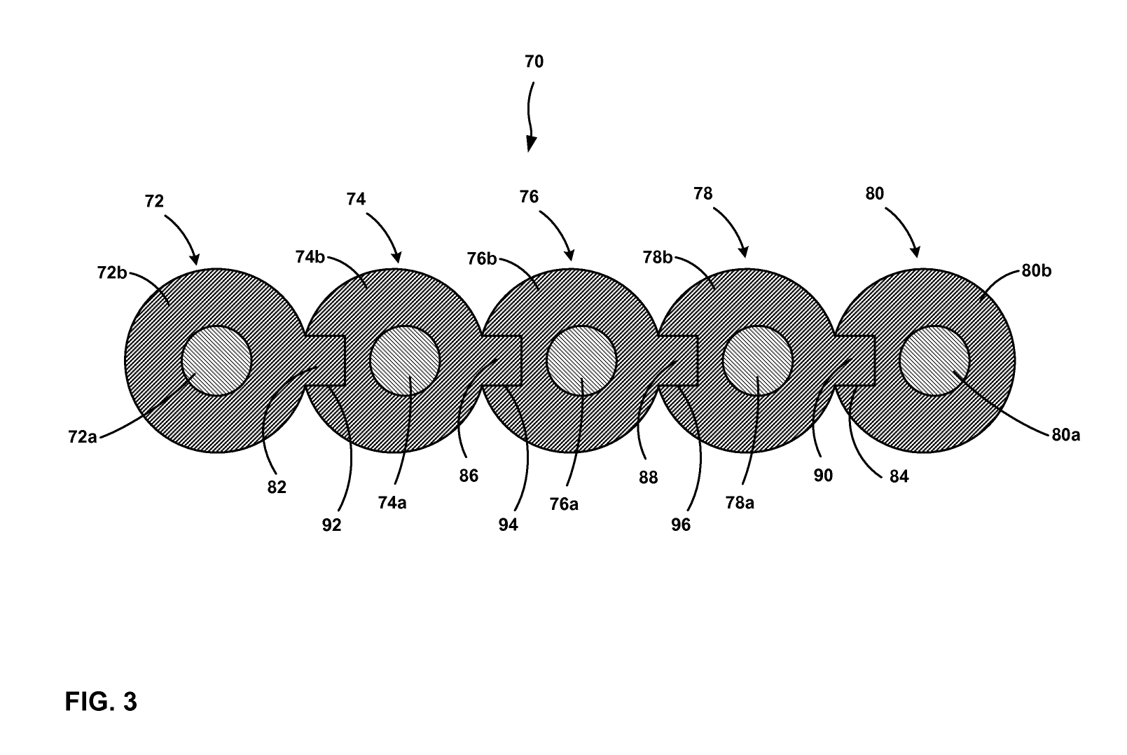

In one example, an optical fiber assembly may be fabricated by interlocking coated fiber 26 with one or more other optical fibers to form an array of optical fibers, where coated fiber 26 is interlocked with an adjacent optical fiber comprising a complementary tongue and/or groove shape by engaging at least one of the tongue or groove defined by the outer periphery of coated fiber 26 with a respective groove or tongue of the adjacent optical fiber. FIG. 3 illustrates an example optical fiber assembly including a number of interlocked optical fibers, some of which may be produced employing drawing tower 10 and coating die 24.

FIG. 3 is a schematic cross-sectional view of optical fiber assembly 70 including first end fiber 72, three intermediate fibers 74-78, and second end fiber 80. In FIG. 3, each of the fibers, 72-80 in assembly 70 is a coated optical fiber including fiber cores 72a-80a, respectively, surrounded by outer coatings 72b-80b, respectively, which define the outermost periphery of the respective fiber. First end fiber 72 includes coating 72b including an outer periphery with tongue 82. Second end fiber 80 includes coating 80b including an outer periphery with groove 84. Intermediate fibers 74-78 include coatings 74b-78b, respectively, including outer peripheries with tongues 86-90 and grooves 92-96, respectively.

In one example, intermediate fibers 74-78 are fabricated using drawing tower 10, which imparts the tongue-and-groove shape to the outer periphery of each of the coatings 74b-78b by at least drawing the fibers and coating through orifice 50 (FIG. 2) of coating die 24. Additionally, in one example, first end fiber 72 may also be fabricated with drawing tower 10, but coating die 24 may be swapped out with another coating die including an orifice configured to form the outer periphery of coating 72b in the illustrated shape including tongue 82, but no groove. Similarly, second end fiber 80 may be fabricated with drawing tower 10, but another coating die may be employed, which includes an orifice configured to form the outer periphery of coating 80b in the illustrated shape including groove 84, but no tongue. In other examples, one or more of fibers 72-80 may be fabricated using different drawing tower systems, one or more of which may include, e.g., different coating dies according to this disclosure. The drawing towers are configured to impart a shape to the coated fibers that enables the fibers to interlock with one or more adjacent fibers, e.g., as shown in FIG. 3.

In fiber assembly 70 of FIG. 3, first end fiber 72 is interlocked with adjacent intermediate fiber 74. In particular, tongue 80 defined by coating 72b of fiber 72 is received by groove 92 defined by coating 74b of fiber 74. The remaining fibers of assembly 70 are similarly interlocked with adjacent fibers 72-80. For example, tongue 86 defined by coating 74b of fiber 74 is received by groove 94 defined by coating 76b of fiber 76. Tongue 88 of coating 76b of fiber 76 is received by groove 96 of coating 78b of fiber 78. Finally, tongue 90 of coating 78b of fiber 76 is received by groove 84 of coating 80b of second end fiber 80.

Optical fiber assembly 70 is an example of an array of optical fibers formed by interlocking a number of fibers with complementary shapes to one another. In particular, optical fiber assembly 70 illustrates a one-dimensional array of fibers. That is, fibers 72-80 are interlocked with adjacent fibers in substantially one direction, which, in the example shown in FIG. 3, is a direction substantially orthogonal to a longitudinal axis of the fibers. Additionally, as illustrated by first end fiber 72 and second end fiber 80 in FIG. 3, interlocking optical fibers according to this disclosure may include complementary shapes to the fibers to which they are interlocked, e.g., intermediate fibers 74 and 78, respectively, in the example of FIG. 3. That is, e.g., first end fiber 72 includes tongue 82, which complements groove 92 defined by coating 74b of an adjacent intermediate fiber 74. However, first end fiber 72 does not itself include a groove, e.g., like groove 92 of intermediate fiber 74. Similarly, second end fiber 80 includes groove 84, which complements tongue 90 of coating 78b defined by intermediate fiber 78. However, second end fiber 80 does not itself include a tongue, e.g., like tongue 90 of intermediate fiber 78. In some cases, a complementary shape may be the same or a substantially similar shape, such as is the case with intermediate fibers 74-78 interlocking with one another in fiber assembly 70. Additionally, fibers and fiber assemblies according to this disclosure may include more than one set of complementary shapes, e.g., a combination of interlocked tongue-and-groove fiber and interlocked star shaped fibers.

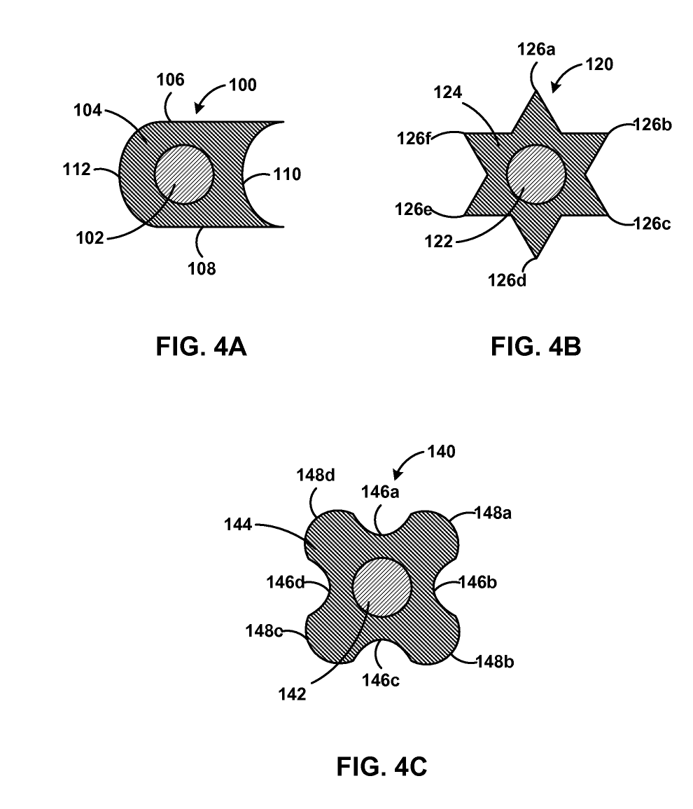

FIGS. 4A-6 illustrate example coated optical fibers with outer peripheries defining shapes other than tongue and groove shapes. The optical fibers shown in FIGS. 4A-6 may be manufactured using methods and systems similar to those described above with reference to coated fiber 26 of FIG. 1 and coated fibers 72-80 of fiber assembly 70 of FIG. 3. For example, the fibers illustrated in the examples of FIGS. 4A-6 may be fabricated with drawing tower 10 of FIG. 1, including, instead of example coating die 24 with tongue-and-groove orifice 50, other coating dies appropriately configured to form the outer periphery of each of the example fibers.

FIGS. 4A-4C are schematic cross-sectional views of three example coated optical fibers according to this disclosure. In FIG. 4A, optical fiber 100 includes fiber core 102 and coating 104. The outer periphery of coating 104 of fiber 100 includes four sides, including generally straight (e.g., planar) sides 106 and 108, concave side 110, and convex side 112. Concave side 110 is generally opposite convex side 110. One advantage of example fiber 100 of FIG. 4A is that the shape of the outer periphery of coating 104 may act to resist relative movement between adjacent interlocked fibers in multiple directions, e.g. in two directions generally orthogonal to one another and to a longitudinal axis of the fiber 100. In FIG. 4B, optical fiber 120 includes fiber core 122 and coating 124. The outer periphery of coating 124 defines a star shape including six points 126a-126f (referred to collectively as “points 126”). In this example, the total outer surface area of coating 124 is increased using the star shaped configuration, which may increase the number of possible interfaces between adjacent interlocked optical fibers in accordance with fiber 120 of FIG. 4B. In FIG. 4C, optical fiber 140 includes fiber core 142 and coating 144. The outer periphery of coating 144 defines four grooves 146a-146d (referred to collectively as “grooves 146”) distributed circumferentially around the periphery. The portions of the outer periphery of coating 144 between each pair of two grooves 146 form four peaks 148a-148d (referred to collectively as “peaks 148”).

Variations of the configurations of the examples of FIGS. 4A-4C are contemplated. For example, an optical fiber according to this disclosure may include a star shaped outer periphery with more or fewer points than the example of FIG. 4B and the points may be unevenly distributed around the periphery of the fiber. Similarly, an optical fiber according to this disclosure may include an outer periphery with more or fewer grooves than the example of FIG. 4C and the grooves may be unevenly distributed around the periphery of the fiber. Moreover, different shapes configured to interlock one optical fiber to another fiber with a complementary shape than those specifically illustrated in the disclosed examples are contemplated. Additionally, different portions along the length of an optical fiber may include different shapes, e.g., a fiber with tongue-and-groove first segment and a star-shape second segment.

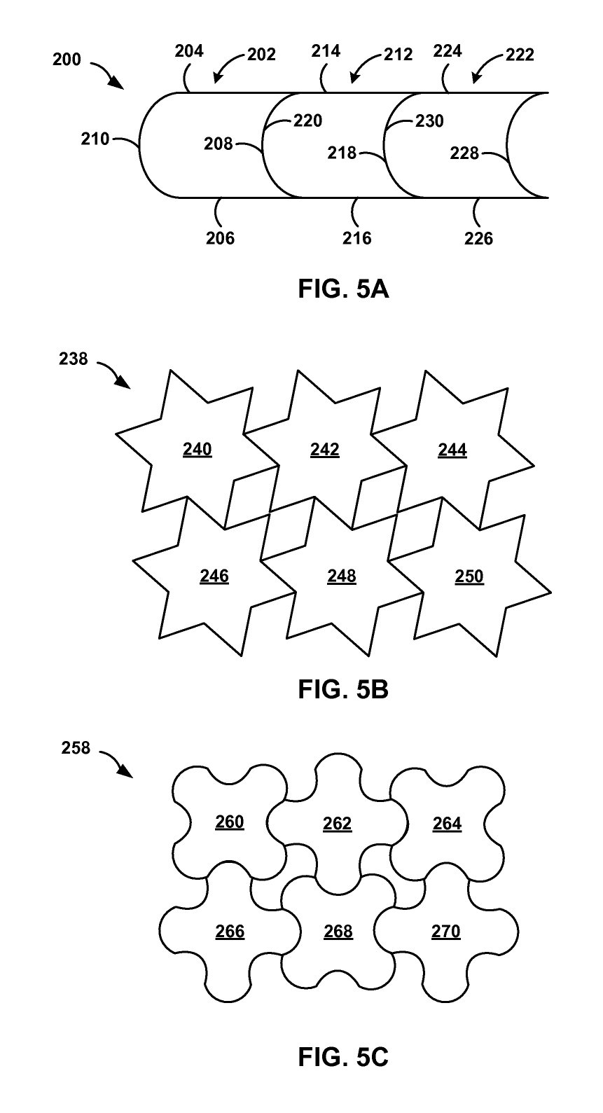

FIGS. 5A-5C are schematic cross-sectional views of a number of optical fiber assemblies that include the example optical fibers of FIGS. 4A-4C. For simplicity of illustration, only the outer periphery of the coating of the optical fibers of FIGS. 4A-4C are illustrated in the assemblies of FIGS. 5A-5C.

FIG. 5A is a cross-sectional view of optical fiber assembly 200 in the form of a one-dimensional array of three interlocking optical fibers in accordance with example optical fiber 100 of FIG. 4A. In FIG. 5A, optical fiber 202 includes an outer periphery including generally straight sides 204 and 206, concave side 208, and convex side 210. Concave side 208 is generally opposite convex side 210. Optical fiber 212 includes an outer periphery including generally straight sides 214 and 216, concave side 218, and convex side 220. Concave side 218 is generally opposite convex side 220. Finally, optical fiber 222 of assembly 200 includes an outer periphery including generally straight sides 224 and 226, concave side 228, and convex side 230. Concave side 228 is generally opposite convex side 230.

In optical fiber assembly 200 of FIG. 5A, optical fiber 202 is interlocked with adjacent optical fiber 212, and, in particular, concave side 208 of optical fiber 202 receives and engages with convex side 220 of optical fiber 212. The remaining fibers of assembly 202 are similarly interlocked with one another. For example, concave side 218 of optical fiber 212 receives and engages with convex side 230 of adjacent optical fiber 222. In another example, additional optical fibers including complementary shapes to those illustrated in fiber assembly 200 of FIG. 5A may be added, including adding one or more fiber to the end of the assembly including fiber 212 and/or adding one or more fiber to the end of the assembly including fiber 222. The fibers added in such examples may have outer peripheries with the same or substantially the same shape as fibers 204, 212, and 222, or other complementary shapes, including, e.g., one of a concave side complementary to one of convex sides 210, 220, or 230, or a convex side complementary to one of concave sides 208, 218, or 228.

FIG. 5B is a schematic cross-sectional view of optical fiber assembly 238 in the form of a two-dimensional array of six interlocking optical fibers 240-250, which each have an outer peripheral shape that corresponds to example optical fiber 120 of FIG. 4B. That is, fibers 240-250 are interlocked with one another in two directions, which, in the example shown in FIG. 3, are two directions substantially orthogonal to one another and to a longitudinal axis of the fibers. In FIG. 5B, each of optical fibers 240-250 includes an outer periphery including a star shape with six points. For simplicity of illustration, the individual points of the star shaped peripheries of fibers 240-250 are assumed to be the same in number, size, and configuration, and are not individually labeled with a reference number. In other examples according to this disclosure, a fiber assembly may include fibers with different star shapes including different numbers and arrangements of points, and different size points (e.g., at least two points of the same fiber can have different sizes).

In optical fiber assembly 238 of FIG. 5B, optical fiber 240 is interlocked with optical fiber 242 and optical fiber 246, and, in particular, one point of optical fiber 240 is received between two points of optical fiber 242 and engages with one of those points of fiber 242, and another point of optical fiber 240 is received between two points of optical fiber 246, and engages with one of those points of fiber 246. The remaining fibers of assembly 238 are similarly interlocked with one another. For example, a first point of optical fiber 242 is received between two points of optical fiber 240, a second point of optical fiber 242 is received between two points of optical fiber 248, and a third point of optical fiber 242 is received between two points of optical fiber 244.

Additionally, one point of optical fiber 244 is received between two points of optical fiber 242 and another point of optical fiber 244 is received between two points of optical fiber 250. One point of optical fiber 246 is received between two points of optical fiber 240 and another point of optical fiber 246 is received between two points of optical fiber 248. A first point of optical fiber 248 is received between two points of optical fiber 246, a second point of optical fiber 248 is received between two points of optical fiber 242, and a third point of optical fiber 248 is received between two points of optical fiber 250. Finally, in example assembly 238 of FIG. 5B, one point of optical fiber 250 is received between two points of optical fiber 248 and another point of optical fiber 250 is received between two points of optical fiber 244.

As noted above, in examples including the star shaped configuration of FIG. 5B, the total outer surface areas of fibers 240-250 are increased using the star shaped configuration. Optical fiber assembly 238 of FIG. 5B illustrates the effect of the increased surface area of fibers 240-250. In particular, increasing the outer surface area increases the number of possible interfaces between adjacent interlocked optical fibers. For example, optical fiber 242 interfaces with three adjacent fibers, 240, 244, and 248, on three different segments of the outer surface of the fiber 242. Similarly, optical fiber 248 interfaces with three adjacent fibers, 246, 250, and 242, on three different segments of the outer surface of the fiber 248.

In other examples according to this disclosure, additional optical fibers including complementary shapes to those illustrated in fiber assembly 238 of FIG. 5B may be added. The fibers added in such examples may have outer peripheries with the same or substantially the same shape as fibers 240-250, or other complementary shapes, including, e.g., more or fewer points, as well as points have different shapes or arranged differently around the outer periphery of the fiber.

FIG. 5C is a cross-sectional view of optical fiber assembly 258, which includes a two-dimensional array of six interlocking optical fibers 260-270 including outer periphery shapes corresponding to example optical fiber 140 of FIG. 4C. In FIG. 5B, each of optical fibers 260-270 includes an outer periphery including four grooves and four peaks formed on the portions of the periphery between every pair of two grooves. For simplicity of illustration, the individual grooves and peaks of fibers 260-270 are assumed to be substantially similar in configuration and not individually labeled in FIG. 5C. In other examples according to this disclosure, a fiber assembly may include fibers with different shaped and arranged grooves and corresponding peaks.

In optical fiber assembly 258 of FIG. 5C, optical fiber 260 is interlocked with optical fiber 262 and optical fiber 266, and, in particular, one groove of optical fiber 260 receives and engages with one peak of optical fiber 262 and another groove of optical fiber 260 receives and engages with one peak of optical fiber 266. The remaining fibers of assembly 258 are similarly interlocked with one another. For example, two other peaks of optical fiber 262, other than the peak received by a groove of fiber 260, are received by and engages with a groove of optical fiber 264 and a groove of optical fiber 268. Another groove of fiber 264, other than the groove that receives a peak of fiber 262, receives and engages with a peak of optical fiber 270. Additionally, another peak of optical fiber 266, other than the peak received by a groove of fiber 260, is received by and engages with a groove of optical fiber 268. Finally, in example assembly 258 of FIG. 5C, another groove of optical fiber 268, other than the grooves that receive a peak from each of fiber 266 and 262, receives a peak of optical fiber 270.

In other examples according to this disclosure, additional optical fibers including complementary shapes to those illustrated in fiber assembly 258 of FIG. 5C may be added. The fibers added in such examples may have outer peripheries with the same or substantially the same shape as fibers 260-270, or other complementary shapes, including, e.g., more or fewer grooves and corresponding peaks, as well as grooves and peaks with different shapes or arranged differently around the outer periphery of the fiber.

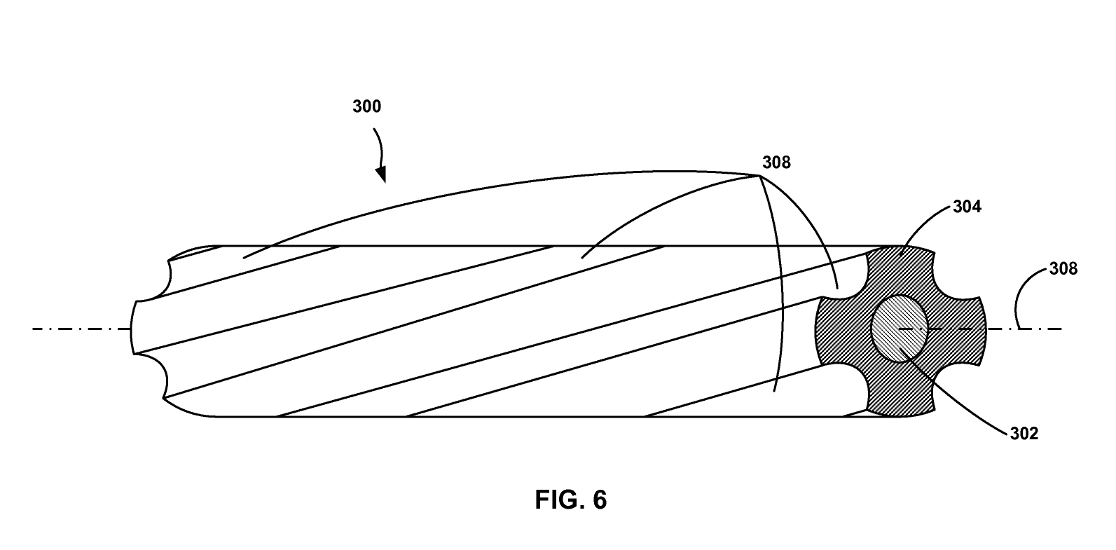

In one example including an optical fiber with an outer periphery generally in the form of example fiber 140 of FIG. 4C and fibers 260-270 of FIG. 5C, the grooves formed in the periphery of the fiber may twist about a longitudinal axis of the fiber as it extends along a length of the fiber. For example, example coated optical fiber 300 illustrated in FIG. 6 includes fiber core 302 and coating 304. The outer periphery of coating 304 is formed with grooves 306. In the example of FIG. 6, grooves 306 twist about longitudinal axis 308 of fiber 300 as they extend along the length of the fiber. In some examples, grooves 306 of fiber 300, or grooves of other similar optical fibers according to this disclosure, may be formed in a helix as they twist about axis 308 of fiber 300. In examples including optical fibers similar to example fiber 300 of FIG. 6, multiple such fibers may be interlocked with one another by, e.g., threading peaks of one of the fibers into grooves of other fibers.

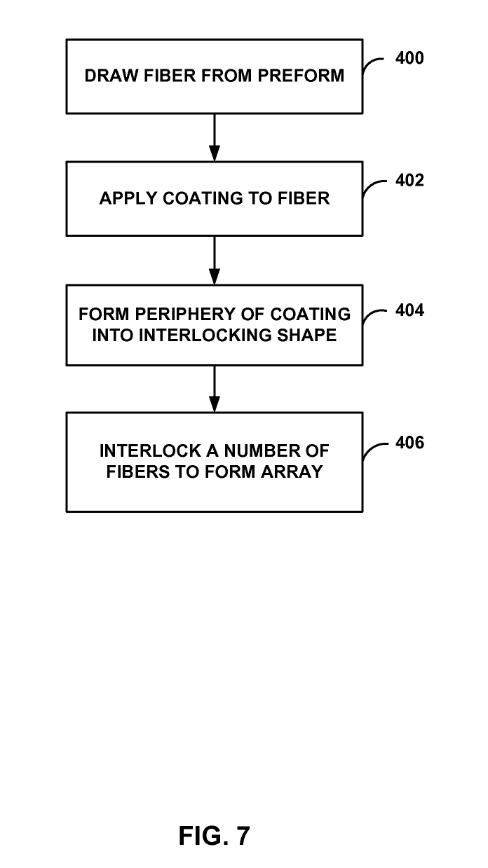

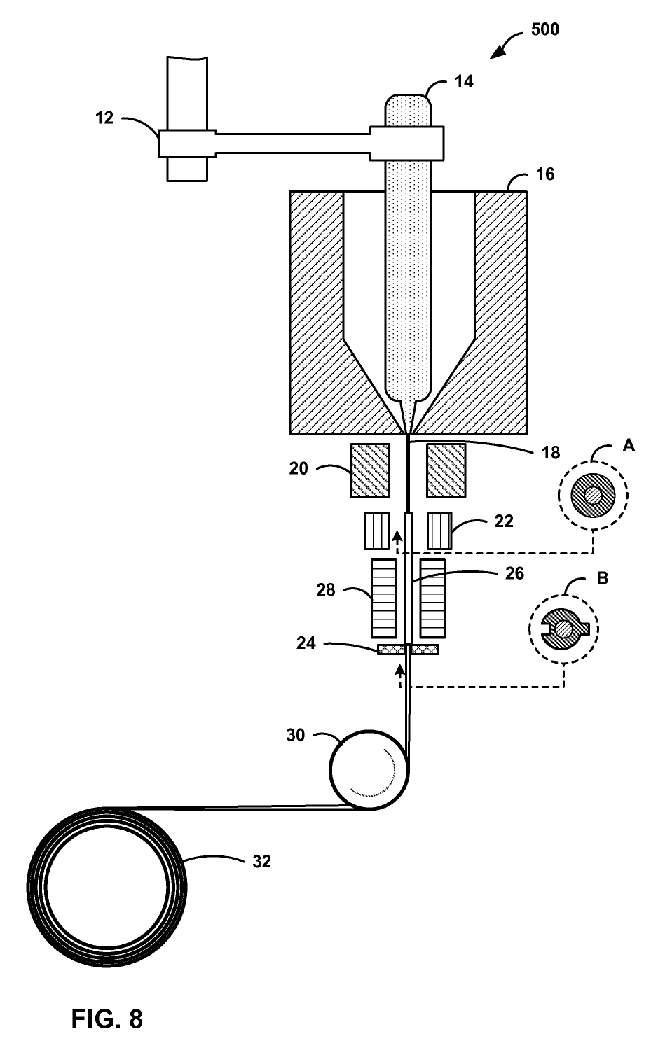

FIG. 7 is a flowchart illustrating an example method of fabricating an optical fiber in accordance with this disclosure. The method of FIG. 7 includes drawing an optical fiber from a preform (400), applying a coating to the fiber (402), forming a periphery of the coating into a shape that configures the fiber to be interlocked with other optical fibers including complementary shapes (404), and interlocking a number of fibers with complementary shaped coatings to form an array of fibers (406). The steps of the method of FIG. 7 for fabricating an optical fiber are described below as carried out using drawing tower 10 of FIG. 1 for purposes of illustration only. In other examples, one or more aspects of the method of FIG. 7 may be carried out by devices or systems that differ from the example of FIG. 1 in constitution and arrangement. For example, as will be illustrated with reference to the alternative example drawing tower illustrated in FIG. 8, a coating die that forms the outer periphery of a coating of an optical fiber in an interlocking shape may be arranged in a different position in a drawing tower than die 24 in example tower 10 of FIG. 1.

The example method of FIG. 7 includes drawing an optical fiber from a preform (400). In one example, feed arm 12 of drawing tower 10 positions preform 14 within draw furnace 16, which may heat the tip of the preform in preparation for drawing optical fiber 18. To begin drawing optical fiber 18, preform 14 is heated in furnace 16 to a temperature that produces a desired drawing tension in optical fiber 18. In one example, preform 14 may be heated to temperatures approaching approximately 1600° C. (3000° F.) to soften the tip of the preform. In any event, the tip of preform 14 may be heated until a piece of molten glass, referred to as a gob, begins to fall from the preform. As gravity causes the gob to fall from preform 14, it pulls behind it a thin strand of glass, which forms the beginning of optical fiber 18. The gob from preform 14 may be cut off, and the beginning of optical fiber 18 may be threaded through core monitor 20, coating applicator 22, die 24, and curing equipment 28 to tractor belt 30 and wound around take-up drum 32.

The method of FIG. 7 also includes applying a coating to the optical fiber drawn from the preform (402). In one example, optical fiber 18 may be drawn through coating applicator 22 of drawing tower 10, which applies a protective coating to the outer surface of the fiber to form coated fiber 26. In some examples, coating applicator 22 may apply multiple coatings to optical fiber 18. The protective coating, however many layers, may act to provide mechanical protection for handling optical fiber 18 and also protect the finely finished surface of the fiber from harsh environments.

In addition to applying a coating to the optical fiber drawn from the preform (402), the method of FIG. 7 includes forming a periphery of the coating into a shape that configures the fiber to be interlocked with other optical fibers including complementary shapes (404). In one example, the shape of coated fiber 26 of FIG. 1 is formed by coating die 24, which is interposed between coating applicator 22 and curing equipment 28. Thus, in the example of FIG. 1, the shape of coated fiber 26, and, in particular, the shape of the outer periphery of the coated fiber is defined as coating applicator 22 applies the coating to optical fiber 18, but before the coating is hardened by curing equipment 28. Coating die 24 is configured to impart a shape to the outer periphery of the coating applied to fiber 18 as the coated fiber 26 is passed through coating die 24.

In other examples, the outer periphery of the coating of an optical fiber may be formed into a shape that configures the fiber to be interlocked with other optical fibers in other ways than illustrated in the example of FIG. 1. FIG. 8 is a block diagram illustrating example optical fiber drawing tower 500 including feed arm 12, preform 14, draw furnace 16, optical fiber 18, core monitor 20, coating applicator 22, die 24, coated fiber 26, curing equipment 28, tractor belt 30, and take-up drum 32. Drawing tower 500 of FIG. 8 may be configured and operate similar to tower 10 described in FIG. 1, including the same components as the example of FIG. 1. Unlike drawing tower 10 of FIG. 1, however, coating die 24 is arranged after curing equipment 28 in example drawing tower 500 of FIG. 8. Thus, in the example of FIG. 8, the shape of coated fiber 26, and, in particular, the shape of the outer periphery of the coated fiber, is defined after coating applicator 22 applies the coating to optical fiber 18 and the coating is hardened by curing equipment 28. For example, coating die 24 may cut or trim the cured coating already applied to fiber 18 from the generally circular state illustrated in detail A in FIG. 8 to the tongue-and-groove interlocking shape illustrated in detail B after the coating is cured and hardened by curing equipment 28.

Other examples for cutting coated fiber 26 after the coating has been cured by curing equipment 28 to form the outer periphery of the fiber into an interlocking shape are also contemplated. For example, instead of employing coating die 24 to cut coated fiber 26, any of a number other material removal processes and devices may be employed, including, e.g., milling or laser or torch cutting the fiber to form the periphery into an interlocking shape according to this disclosure. Additionally, although the example of FIG. 8 shows coated fiber formed into a tongue-and-groove interlocking shape, such examples of cutting the already cured fiber may be applied to form other interlocking shapes, including those described above with reference to FIGS. 4A-6.

Although the foregoing examples describe forming the outer periphery of the coating of an optical fiber in an interlocking shape, in some examples according to this disclosure, the optical fiber itself may be formed into the interlocking shape and the coating may assume the shape of the fiber. As noted above, and is the case in the foregoing specific examples, an optical fiber drawn from a preform 14 may have a generally round cross sectional shape, including, e.g., a generally circular cross-sectional shape or a generally oval cross-sectional. The shape of optical fiber 18 thus configured may enhance the optical and environmental performance of the fiber. However, in some examples, forming the optical fiber itself, versus just the outer coating, into alternative shapes including interlocking shapes in accordance with this disclosure may be acceptable and even desirable in terms of the performance of the fiber. Thus, examples according to this disclosure are not limited to forming the outer coating into an interlocking shape while maintaining the optical fiber surrounded by the coating in a non-interlocking shape, such as circular or oval.

Referring again to FIG. 7, the example method includes interlocking a number of fibers with complementary shaped coatings to form an array of fibers (406). Interlocking fibers to one another may be done manually or with the assistance of automation machinery configured to index and assemble the fibers. In one example, fibers 72-80 are interlocked with one another to form a one dimensional fiber assembly 70 of FIG. 3. In the example of fiber assembly 70 of FIG. 3, first end fiber 72 of is interlocked with intermediate fiber 74 via the respective tongue 80 and groove 92. The remaining fibers of assembly 70 are similarly interlocked with one another, as described above with respect to FIG. 3. Other example optical fiber assemblies are included in the example method of FIG. 7, including, e.g., one and two-dimensional array of fibers illustrated in example assemblies 200, 238, and 258 of FIGS. 5A-5C, respectively.

Examples according to this disclosure provide a number of advantages for the production of optical fibers and the assembly of a number of fibers into one and two-dimensional arrays. The disclosed examples can be easily adapted to some existing manufacturing systems, thus requiring very little upfront cost to begin producing optical fibers with interlocking shapes in accordance this disclosure. For example, a coating die (e.g., die 24 shown in FIGS. 1, 2, and 8) that imparts a shape to an outer periphery of an optical fiber (e.g., to the fiber itself or the coated fiber) may be added to an existing fiber optic drawing tower with relatively little modification to the existing system.

Implementation of interlocking optical fibers according to this disclosure into a manufacturing process can also remove one step from the production fiber assemblies. For example, in some cases, optical fibers according to this disclosure may be assembled by interlocking the fibers to one another without the use of any adhesive, tape, welding, or other mechanical, thermal or chemical securing mechanism in addition to the interlocking fibers, and still produce an optical fiber array with satisfactory mechanical stability. Removing the step of applying adhesive to connect multiple optical fibers in a fiber assembly may act to reduce the time, complexity, and cost of producing such assemblies. However, adhesive can be used to secure interlocking optical fibers to each other in some examples.

Various examples have been described. These and other examples are within the scope of the following claims.

1. A method comprising:
drawing a first optical fiber from a preform; and
forming an outer periphery of the first optical fiber into a shape that configures the first optical fiber to be interlocked with a second optical fiber comprising a complementary outer periphery shape.

2. The method of claim 1, further comprising interlocking one or more optical fibers and the first optical fiber to form an array of fibers.

3. The method of claim 2, wherein the array of fibers comprises at least one of a one or two-dimensional array of fibers.

4. The method of claim 1, wherein the shape of the first optical fiber comprises at least one of a tongue and groove shape, a curvilinear shape comprising a concave side generally opposing a convex side, a star comprising a plurality of points, or a plurality of grooves distributed circumferentially around the periphery of the fiber, wherein portions of the periphery between two grooves forms a peak.

5. The method of claim 4, further comprising interlocking the first optical fiber to the second optical fiber by at least one of receiving the tongue of the first optical fiber in a groove of the second optical fiber or receiving a tongue of the second optical fiber in the groove of the first optical fiber.

6. The method of claim 4, further comprising interlocking the first optical fiber to the second optical fiber by at least one of receiving the convex side of the first optical fiber in a concave side of the second optical fiber or receiving a convex side of the second optical fiber in the concave side of the first optical fiber.

7. The method of claim 4, wherein the shape of the second optical fiber comprises a star comprising a plurality of points, the method further comprising interlocking the first optical fiber to the second optical fiber by at least one of receiving one point of the first optical fiber between two points of the second optical fiber or receiving one point of the second optical fiber between two points of the first optical fiber.

8. The method of claim 1, wherein the shape of the second optical fiber comprises a plurality of grooves distributed circumferentially around the outer periphery of the fiber, wherein portions of the outer periphery between two grooves forms a peak, the method further comprising interlocking the first optical fiber with the second optical fiber by at least one of receiving a peak of the first optical fiber in a groove of the second optical fiber or receiving a peak of the second optical fiber in a groove of the first optical fiber.

9. The method of claim 8, further comprising interlocking the first optical fiber to the second optical fiber by at least one of threading a peak of the second optical fiber into a groove of the first optical fiber or threading a peak of the first optical fiber into a groove of the second optical fiber.

10. The method of claim 1, further comprising applying a coating to the first optical fiber, and wherein forming the outer periphery of the first optical fiber into the shape that configures the first optical fiber to be interlocked with the second optical fiber comprises forming an outer periphery of the coating of the first optical fiber into a shape that configures the first optical fiber to be interlocked with the second optical fiber.

11. The method of claim 10, further comprising curing the coating applied to the first optical fiber, and wherein forming an outer periphery of the coating of the first optical fiber into a shape that configures the first optical fiber to be interlocked with the second optical fiber comprises cutting the outer periphery of the coating of the first optical fiber into the shape that configures the first optical fiber to be interlocked with the second optical fiber.

12. The method of claim 1, further comprising applying a coating to the first optical fiber, and wherein an outer periphery of the coating of the first optical fiber assumes the shape of the outer periphery of the first optical fiber.

13. An optical fiber comprising:
a core;
a cladding surrounding the core; and
a coating surrounding the cladding,
wherein at least one of the core, the cladding, or the coating comprises an outer periphery formed in a shape that configures the optical fiber to be interlocked with another optical fiber comprising a complementary outer periphery shape.

14. The optical fiber of claim 13, wherein the shape of the optical fiber comprises at least one of a tongue or a groove such that at least one of the tongue or groove of the optical fiber is configured to be engage with a respective groove or tongue of another optical fiber.

15. The optical fiber of claim 13, wherein the shape of the optical fiber comprises a curvilinear shape comprising a concave side generally opposite a convex side such that at least one of the convex side of the optical fiber is configured to be received in a concave side of another optical fiber or the concave side of the optical fiber is configured to receive a convex side of another optical fiber.

16. The optical fiber of claim 13, wherein the shape of the optical fiber comprises a star comprising a plurality of points such that at least one of one point of the optical fiber is configured to be received between two points of another star shaped optical fiber or two points of the optical fiber are configured to receive one point of another star shaped optical fiber.

17. The optical fiber of claim 13, wherein the shape of the optical fiber comprises a plurality of grooves distributed circumferentially around the periphery of the fiber and wherein portions of the periphery between two grooves forms a peak such that at least one of a peak of the optical fiber is configured to be received in a groove of another complementary shaped optical fiber or a groove of the optical fiber is configured to receive a peak of another complementary shaped optical fiber.

18. The optical fiber of claim 13, further comprising a second optical fiber comprising an outer periphery shape complementary to the shape of the outer periphery of the first optical fiber, wherein the second optical fiber is interlocked with the first optical fiber to form an optical fiber assembly.

19. A system for manufacturing optical fibers, the system comprising:
a preform from which an optical fiber is drawn; and
a die comprising an orifice through which the optical fiber is drawn and by which an outer periphery of the optical fiber is formed into a shape that configures the optical fiber to be interlocked with another optical fiber comprising a complementary outer periphery shape.
